(19) United States
(12) Patent Application Publication
(10) Pub. No.: US 2023/0173879 A1
(43) Pub. Date: Jun. 8, 2023

(54) DATA ANALYSIS OF ENVIRONMENTAL DATA FOR MANAGING TEMPERATURE OF A TRANSPORT ENVIRONMENT

(71) Applicant: International Business Machines Corporation, Armonk, NY (US)

(72) Inventors: Thomas Jefferson Sandridge, Tampa, FL (US); Tushar Agrawal, West Fargo, ND (US); Jeremy R. Fox, Georgetown, TX (US); Sarbajit K. Rakshit, Kolkata (IN); Michael Boone, Lutz, FL (US)

(21) Appl. No.: 17/457,629

(22) Filed: Dec. 3, 2021

(51) Int. Cl. B60H 1/00; G05B 17/02; G01C 21/36

(52) U.S. Cl. CPC B60H 1/00878; G01C 21/3691; G05B 17/02

(57) ABSTRACT

Proactive temperature maintenance in a temperature controlled unit of a delivery vehicle can be based on a computer data analysis of multiple temperature factors. A computer can receive route environmental data from a multiplicity of sources regarding temperatures outside a vehicle, including a temperature at a current location and temperatures at another location along a route of the vehicle. Route environmental data can be analyzed to determine when to initiate a proactive cooling action for maintaining a cooling requirement within a refrigerated space within the vehicle, and the cooling requirements can include a threshold temperature in the refrigerated space. A proactive cooling action can be initiated based on the analysis before the threshold temperature is reached by assessing temperature variations in the route environmental data for determining a temperature effect on the vehicle at one or more locations along the route.

### BACKGROUND

The present disclosure relates to data analysis of environmental data for managing a transport environment for temperature sensitive products, and more specifically, can relate to proactive cooling or heating in a temperature controlled transport environment, such as a delivery vehicle having a refrigeration unit.

In one example, a delivery vehicle can transport various products from one location to another location with a controlled temperature environment to be maintained. In one example, a cooling system of the vehicle maintains a temperature in a temperature controlled unit. In one example, the delivery vehicle maintains a controlled temperature while products are being transported. Further, to maintain a temperature or temperature range, the vehicle consumes power to maintain the temperature. The delivery vehicle can maintain a proper or specified temperature for products while the products are being transported. In an example of maintain cooling or refrigeration, if unnecessary cooling is applied to a refrigeration unit, transportation cost will be increased.

Other issues when transporting products and maintaining environmental temperatures can include, how to maintain temperature for an amount of products, or the environmental temperature and environmental condition outside the vehicle.

### SUMMARY

The present disclosure recognizes the shortcomings and problems associated with current techniques for proactive temperature maintenance, in a temperature controlled unit of a delivery vehicle, based on computer data analysis of multiple environmental factors.

In one example according to the present invention, a method and system can include a delivery vehicle proactively gathering information from crowdsource vehicles to identify road surface temperature along with the route of the vehicle, including traffic speed, etc., and accordingly a system can include applying cooling so that, at no point of time, the temperature in a temperature controlled unit crosses the allowed limit.

In another example, a controlled temperature unit in a vehicle can maintain a temperature. A delivery vehicle can maintain the controlled temperature while the products are being transported. Maintaining the temperature requires power, for example, keeping the temperature controlled unit refrigerated at a specified temperature. Such power can be supplied from running the engine of the vehicle which requires fuel, thus fuel consumption can be increased with more power required to maintain a temperature. Maintaining a steady temperature in the temperature controlled unit can advantageously effect fuel consumption. When the temperature in the unit is allowed to spike or increase or decrease faster, it can take more power to maintain the temperature. Thus, it is advantageous to maintain a steady temperature, and encourage less temperature variations from a desired temperature in the temperature controlled unit. For example, if more cooling/refrigeration needs to be applied, then transportation costs will be increased.

In one example, an ambient temperature and a required temperature to be maintained in a temperature controlled unit for products being transported. An amount of cooling can depend on the amount of products present inside the unit. Different areas of a roadway can have different degrees of ambient temperature, for example, types of material used for building the road, traffic condition, etc., can affect ambient temperature along a roue. In one example, after a vehicle reaches a location, the ambient temperature is measured and appropriate cooling is applied, however, it may be too late to control a temperature effectively, e.g., the temperature inside the unit can move above a threshold. Thus, proactive cooling of the unit using a controlling mechanism would be beneficial. Embodiments of the present invention includes a method and system by which, a delivery vehicle can proactively gather information from crowdsource vehicles to identify road surface temperature along a route of the vehicle, including traffic speed, etc., and accordingly the system can proactively apply cooling to a unit within the vehicle so that, at no point of time, is a threshold temperature crossed.

In an aspect according to the present invention, a computer-implemented method for proactive temperature maintenance in a temperature controlled unit of a delivery vehicle based on computer data analysis of multiple temperature factors includes receiving route environmental data, at a computer, from a multiplicity of sources regarding temperatures outside a vehicle including a temperature at a current location and temperatures at another location along a route of the vehicle. The method includes analyzing the route environmental data to determine when to initiate a proactive cooling action for maintaining a cooling requirement within a refrigerated space within the vehicle, the cooling requirements include a threshold temperature in the refrigerated space. The method includes initiating the proactive cooling action based on the analysis before the threshold temperature is reached by assessing temperature variations in the route environmental data for determining a temperature effect on the vehicle at one or more locations along the route.

In a related aspect, the maintaining of the cooling requirements includes maintaining a temperature range.

In a related aspect, the method further includes maintaining the cooling requirement as a result of the initiated proactive cooling action.

In a related aspect, the proactive cooling action can be initiated in anticipation of initiating increased cooling by a refrigeration system to maintain the cooling requirements in the vehicle and avoid reaching the threshold temperature in the refrigerated space of the vehicle.

In a related aspect, the multiplicity of sources is from a plurality of wireless devices communicating with the computer.

In a related aspect, the sources can include the location or locations along a route, or a road surface, or weather sensing sensors at the location or at the locations along the route.

In a related aspect, the computer is part of the vehicle.

In a related aspect, the computer is remote from the vehicle and communicates with a vehicle computer in the vehicle.

In a related aspect, a source of the multiplicity of the sources is a weather service system.

In a related aspect, the analysis of the data includes assessing a risk of the temperature reaching the threshold temperature at the one or more locations; determining when the risk meets a risk threshold; and the initiating of the proactive cooling action being based on the analysis and when the risk meets the risk threshold.

In a related aspect, the method further includes generating a model, using the computer, wherein the model includes the following; updating the analysis of the route environmental data; updating the assessing of the temperature variations of the route environmental data, and updating the determining of the temperature effect on the vehicle; and updating the initiating of the proactive cooling action being based on the updated analysis and the updated assessing of the temperature variations.

In a related aspect, the method further includes iteratively generating the model to produce updated models.

In another aspect according to the present invention, a system for proactive temperature maintenance in a temperature controlled unit of a delivery vehicle based on computer data analysis of multiple temperature factors includes a computer system. The computer system includes a computer processor, a computer-readable storage medium, and program instructions stored on the computer-readable storage medium being executable by the processor, to cause the computer system to perform the following functions to; receive route environmental data, at a computer, from a multiplicity of sources regarding temperatures outside a vehicle including a temperature at a current location and temperatures at another location along a route of the vehicle; analyze the route environmental data to determine when to initiate a proactive cooling action for maintaining a cooling requirement within a refrigerated space within the vehicle, the cooling requirements include a threshold temperature in the refrigerated space; and initiate the proactive cooling action based on the analysis before the threshold temperature is reached by assessing temperature variations in the route environmental data for determining a temperature effect on the vehicle at one or more locations along the route.

In a related aspect, the maintaining of the cooling requirements includes maintaining a temperature range.

In a related aspect, the system further includes maintaining the cooling requirement as a result of the initiated proactive cooling action.

In a related aspect, the proactive cooling action is initiated in anticipation of initiating increased cooling by a refrigeration system to maintain the cooling requirements in the vehicle and avoid reaching the threshold temperature in the refrigerated space of the vehicle.

In a related aspect, the multiplicity of sources is from a plurality of wireless devices communicating with the computer.

In a related aspect, the sources include the location or locations along a route, or a road surface, or weather sensing sensors at the location or at the locations along the route.

In a related aspect, the computer is part of the vehicle.

In an aspect according to the present invention, a computer program product for proactive temperature maintenance in a temperature controlled unit of a delivery vehicle based on computer data analysis of multiple temperature factors includes a computer readable storage medium having program instructions embodied therewith. The program instructions are executable by a computer to cause the computer to perform functions, by the computer, comprising the functions to; receive route environmental data, at a computer, from a multiplicity of sources regarding temperatures outside a vehicle including a temperature at a current location and temperatures at another location along a route of the vehicle; analyze the route environmental data to determine when to initiate a proactive cooling action for maintaining a cooling requirement within a refrigerated space within the vehicle, the cooling requirements include a threshold temperature in the refrigerated space; and initiate the proactive cooling action based on the analysis before the threshold temperature is reached by assessing temperature variations in the route environmental data for determining a temperature effect on the vehicle at one or more locations along the route.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. The drawings are discussed forthwith below.

FIG. 1 is a schematic block diagram illustrating an overview of a system, system features or components, and methodology for proactive temperature maintenance in a temperature controlled unit of a delivery vehicle based on computer data analysis of multiple temperature factors, according to an embodiment of the present disclosure.

FIG. 2 is a flow chart illustrating a method, implemented using the system shown in FIG. 1, for proactive temperature maintenance in a temperature controlled unit of a delivery vehicle based on computer data analysis of multiple temperature factors.

FIG. 3 is a functional schematic block diagram showing a series of operations and functional methodologies, for instructional purposes illustrating functional features of the present disclosure associated with the embodiments shown in the FIGS., which can be implemented, at least in part, in coordination with the system shown in FIG. 1, for proactive temperature maintenance in a temperature controlled unit of a delivery vehicle based on computer data analysis of multiple temperature factors.

FIG. 4 is a flow chart illustrating another method, which continues from the flow chart of FIG. 2, which includes generating a model for proactive temperature maintenance in a temperature controlled unit of a delivery vehicle based on computer data analysis of multiple temperature factors.

FIG. 5 is a flow chart illustrating another method according to an embodiment of the present invention, for proactive temperature maintenance in a temperature controlled unit of a delivery vehicle based on computer data analysis of multiple temperature factors.

FIG. 6 is a schematic block diagram depicting a computer system according to an embodiment of the disclosure which may be incorporated, all or in part, in one or more computers or devices shown in FIG. 1, and cooperates with the systems and methods shown in the FIGS.

FIG. 7 is a block diagram depicting a cloud computing environment according to an embodiment of the present invention.

FIG. 8 is a block diagram depicting abstraction model layers according to an embodiment of the present invention.

### DETAILED DESCRIPTION

The following description with reference to the accompanying drawings is provided to assist in a comprehensive understanding of exemplary embodiments of the invention as defined by the claims and their equivalents. The description includes various specific details to assist in that understanding, but these are to be regarded as merely exemplary, and assist in providing clarity and conciseness. Accordingly, those of ordinary skill in the art will recognize that various changes and modifications of the embodiments described herein can be made without departing from the scope and spirit of the invention. In addition, descriptions of well-known functions and constructions may be omitted.

The terms and words used in the following description and claims are not limited to the bibliographical meanings, but are merely used to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

### Embodiments and Examples

Embodiments and figures of the present disclosure may have the same or similar components as other embodiments. Such figures and descriptions of illustrate and explain further examples and embodiments according to the present disclosure.

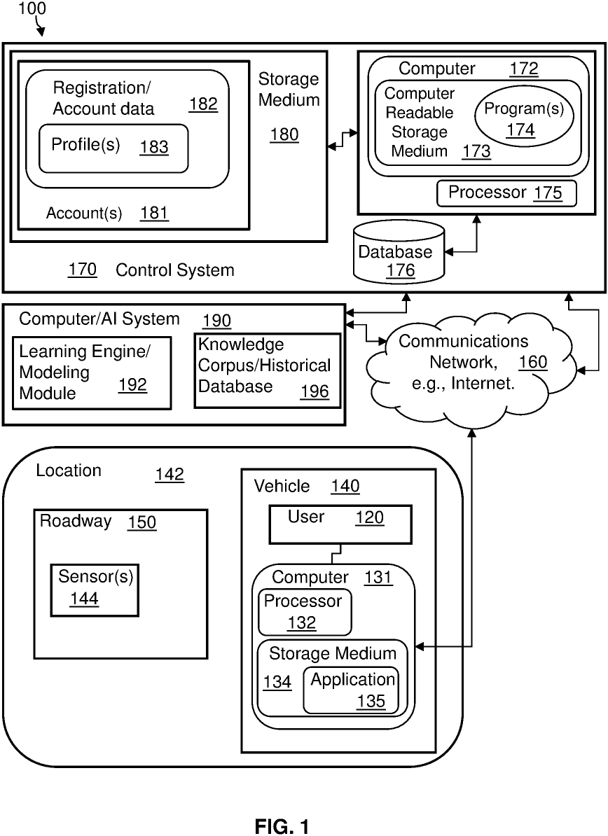

Referring to FIGS. 1, 2 and 3, according to embodiments of the present disclosure, a computer-implemented method 200 for proactive temperature maintenance in a temperature controlled unit 304 of a delivery vehicle 140 based on computer data analysis 320 of multiple temperature factors. Embodiments of the present disclosure include operational actions and/or procedures. The computer-implemented method 200 includes a series of operational blocks for implementing an embodiment according to the present disclosure which can include the system shown in FIG. 1. The operational blocks of the methods and systems according to the present disclosure can include techniques, mechanism, modules, and the like for implementing the functions of the operations in accordance with the present disclosure.

Referring to FIGS. 1, 2 and 3, the method 200 includes receiving route environmental data 308, at a computer 131, including roadway/road surface data 312 from sensors 144 along or at one or more locations on a roadway 150. The data can be from a multiplicity of sources regarding temperatures outside a vehicle including a temperature at a current location 142 and temperatures at another location along a route 305 of the vehicle 140, as in block 204. The location 142 can represent one or more locations.

The method includes analyzing the route environmental data 308 to determine when to initiate a proactive cooling action 326 for maintaining a cooling requirement 328 within a refrigerated space 304 within the vehicle 140. The cooling requirements include a threshold temperature 330 in the refrigerated space 304, as in block 208. The data analysis can include generating a computer model 324.

When the method 200 does not accept or approve a proactive cooling action, at block 210, the method returns to block 208. When the method 200 accepts or approves an acceptable proactive cooling action, at block 210, the method proceeds to block 212.

The method includes initiating 334 the proactive cooling action 326 based on the analysis 320 before the threshold temperature 330 is reached by assessing temperature variations in the route environmental data 308 for determining a temperature effect 325 on the vehicle at one or more locations along the route 305, as in block 212.

In one example, the maintaining of the cooling requirements can include maintaining a temperature range.

In another example, the method can further include maintaining the cooling requirement as a result of the initiated proactive cooling action.

In another example, the method can include the proactive cooling action being initiated in anticipation of initiating increased cooling by a refrigeration system to maintain the cooling requirements in the vehicle, and avoid reaching the threshold temperature in the refrigerated space of the vehicle.

In another example, the multiplicity of sources can be from a plurality of wireless devices communicating with the computer.

In another example, the sources can include the location or locations along a route, or a road surface, or weather sensing sensors at the location or at the locations along the route.

In another example, the computer can be part of the vehicle.

In another example, the computer can be remote from the vehicle and communicates with a vehicle computer in the vehicle.

In another example, a source of the multiplicity of the sources can be a weather service system.

In another example, the analysis of the data can include assessing a risk of the temperature reaching the threshold temperature at the one or more locations, and determining when the risk meets a risk threshold. And the initiating of the proactive cooling action can be based on the analysis and when the risk meets the risk threshold.

In another example, the method can further include generating a model, using the computer. The model can include updating the analysis of the route environmental data; updating the assessing of the temperature variations of the route environmental data, updating the determining of the temperature effect on the vehicle; and updating the initiating of the proactive cooling action being based on the updated analysis and the updated assessing of the temperature variations.

In another example, the method can further include iteratively generating the model to produce updated models.

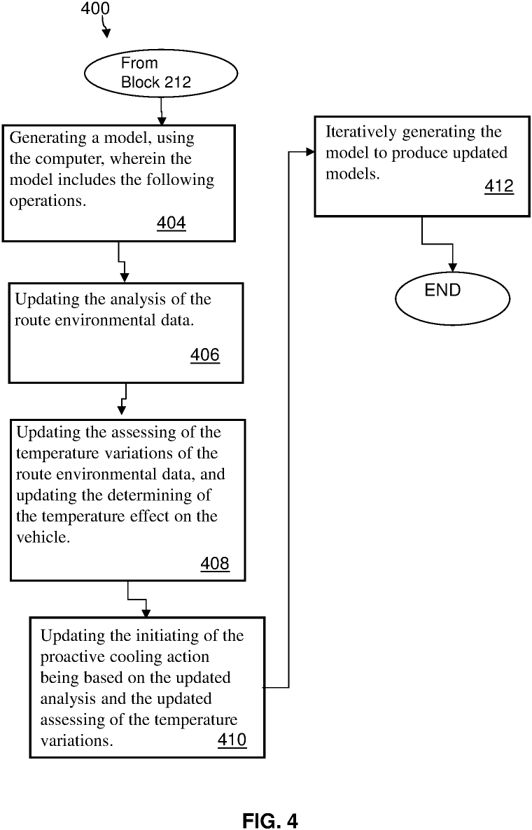

Referring to FIG. 4, for example, in another embodiment according to the present disclosure, a method 400 for proactive temperature maintenance in a temperature controlled unit of a delivery vehicle includes generating a model, using a computer, which can continue from block 212 of the method 200, and can include the following operations, as in block 404. The model can be generated using a learning engine or modeling module 192 of a computer system 190 which can be all or in part of an Artificial Intelligence (AI) system which communicates with the computer 131 and/or a control system 170. Such a computer system 190 can include or communicate with a knowledge corpus or historical database 196.

In one example, a method can determine when a model is acceptable, and the method can proceed with operations. In one example, an acceptable model can include a model meeting specified parameters. In another example, an acceptable model can be a model which has undergone several iterations. When the model is not acceptable, a method can return to a previous operation represented by a block in a flowchart. In one example, when a set of parameters are acceptable, a method can proceed to another operation represented by a block in a flowchart. In one example, an acceptable set of parameters can include parameters meeting specified criteria. When the parameters are not acceptable, the method can return to block 212.

The method 400 includes updating the analysis of the route environmental data, as in block 406. The method 400 can include updating the assessing of the temperature variations of the route environmental data, and updating the determining of the temperature effect on the vehicle, as in block 408. The method 400 can include updating the initiating of the proactive cooling action being based on the updated analysis and the updated assessing of the temperature variations, as in block 410. The method 400 can include iteratively generating the model to produce updated models, as in block 412.

The computer 131 can be integral to or communicating with the robotic device 148 in a device 130. A computer 190 remote from the device 148 can electronically communicate, in all or in part, with the computer 172 as part of the control system 170. The control system can include the computer 172 having a computer readable storage medium 173 which can store one or more programs 174, and a processor 175 for executing program instructions. The control system can also include a storage medium which can include registration and/or account data 182 and profiles 183 of users or entities (such entities can include robotic entities) as part of user accounts 181. User accounts 181 can be stored on a storage medium 180 which is part of the control system 170. The user accounts 181 can include registrations and account data 182 and user profiles 183. The control system can also include a computer 172 having a computer readable storage medium 173 which can store programs or code embedded on the storage medium. The program code can be executed by a processor 175. The computer 172 can communicate with a database 176. The control system 170 can also include a database 176 for storing all or part of such data as described above, and other data.

The control system can also communicate with a computer system 190 which can include a learning engine/module 192 and a knowledge corpus or database 196. The computer system 190 can also communicate with the computer 131 of the device 130 and can be remote from the user device 130. In another example, the computer system 190 can be all or part of the control system, or all or part of the device 130. The depiction of the computer system 190 as well as the other components of the system 100 are shown as one example according to the present disclosure.

The new or different AI (Artificial Intelligence) ecosystem, or technology/communication or IT (Information Technology) ecosystem can include a local communications network 152 which can communicate with the communications network 160. The system 100 can include a learning engine/module 192, which can be at least part of the control system or communicating with the control system, for generating a model or learning model. In one example, the learning model can model workflow in a new AI or IT ecosystem for machine/devices in the new ecosystem.

In another example, the computer 131 can be part of a device 130. The computer can include a processor 132 and a computer readable storage medium 134 where an application 135 can be stored which can in one example, embody all or part of the method of the present disclosure. The application can include all or part of instructions to implement the method of the present disclosure, embodied in code and stored on a computer readable storage medium. The device 148 can include a display. The device 148 can operate, in all or in part, in conjunction with a remote server by way of a communications network 160, for example, the Internet.

The method can include an analysis generating a model 324 based on received data. A model can also be generated by an AI system such as an output at least in part of an AI system analysis using machine learning.

### Other Embodiments and Examples

Referring to FIG. 1, the device 130, also can be referred to as a user device or an administrator’s device, includes a computer 131 having a processor 132 and a storage medium 134 where an application 135, can be stored. The application can embody the features of the method of the present disclosure as instructions. The user can connect to a learning engine 150 using the device 130. The device 130 which includes the computer 131 and a display or monitor 138. The application 135 can embody the method of the present disclosure and can be stored on the computer readable storage medium 134. The device 130 can further include the processor 132 for executing the application/software 135. The device 130 can communicate with a communications network 160, e.g., the Internet.

It is understood that the user device 130 is representative of similar devices which can be for other users, as representative of such devices, which can include, mobile devices, smart devices, laptop computers etc.

In one example, the system of the present disclosure can include a control system 170 communicating with the user device 130 via a communications network 160. The control system can incorporate all or part of an application or software for implementing the method of the present disclosure. The control system can include a computer readable storage medium 180 where account data and/or registration data 182 can be stored. User profiles 183 can be part of the account data and stored on the storage medium 180. The control system can include a computer 172 having computer readable storage medium 173 and software programs 174 stored therein. A processor 175 can be used to execute or implement the instructions of the software program. The control system can also include a database 176.

In another example and embodiment, profiles can be saved for entities such as users, participants, operators, human operators, or robotic devices. Such profiles can supply data regarding the user and history of deliveries for analysis. In one example, a user can register or create an account using the control system 170 which can include one or more profiles 183 as part of registration and/or account data 182. The registration can include profiles for each user having personalized data. For example, users can register using a website via their computer and GUI (Graphical User Interface) interface. The registration or account data 182 can include profiles 183 for an account 181 for each user. Such accounts can be stored on the control system 170, which can also use the database 176 for data storage. A user and a related account can refer to, for example, a person, or an entity, or a corporate entity, or a corporate department, or another machine such as an entity for automation such as a system using, in all or in part, artificial intelligence.

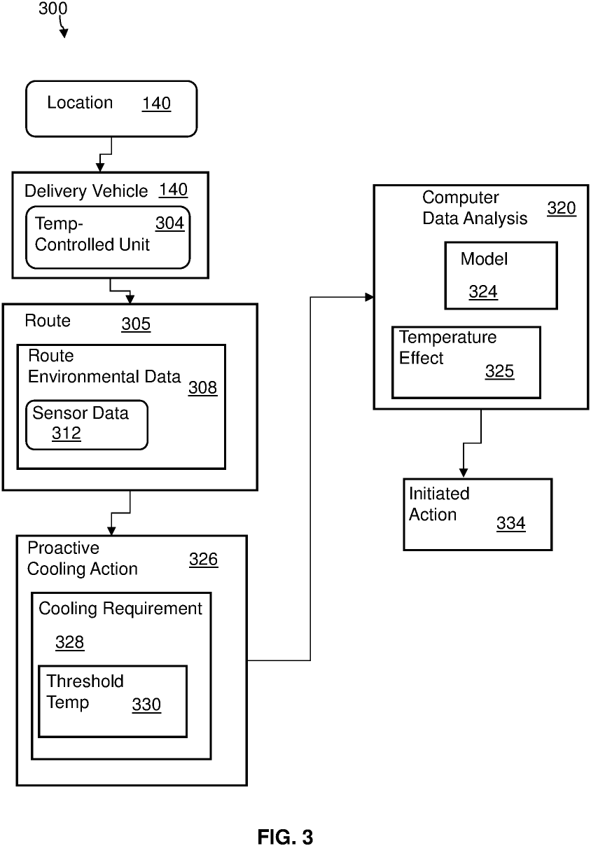

Additionally, the method and system is discussed with reference to FIG. 3, which is a functional system 300 which includes components and operations for embodiments according to the present disclosure, and is used herein for reference when describing the operational steps of the methods and systems of the present disclosure. Additionally, the functional system 300, according to an embodiment of the present disclosure, depicts functional operations indicative of the embodiments discussed herein.

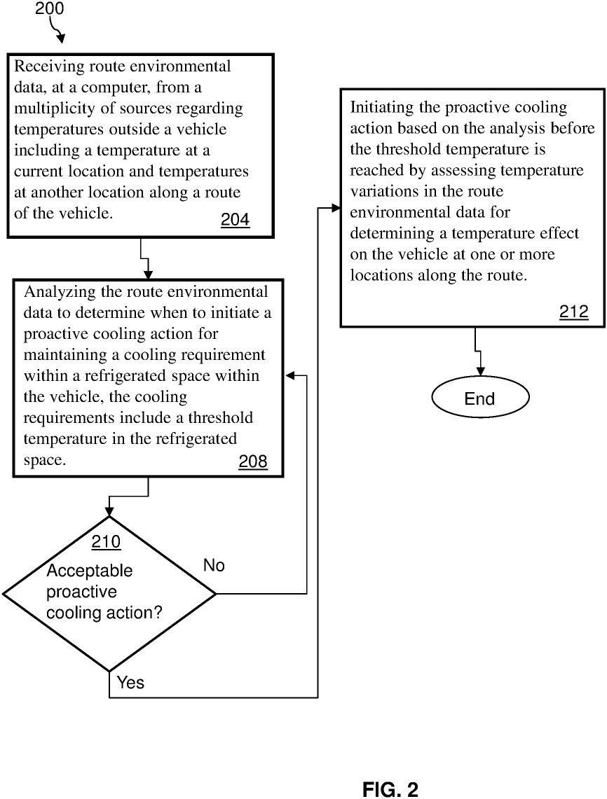

Referring to FIG. 3, in one embodiment according to the present disclosure, a system 300 can be used to identify objects related to an event for use regarding the event by using networked computer system resources. In FIG. 3 similar components may have the same reference numerals as the system 100 shown in FIG. 1, the system 300 can include or operate in concert with a computer implemented method as shown in FIGS. 1 and 2.

### More Embodiments and Examples

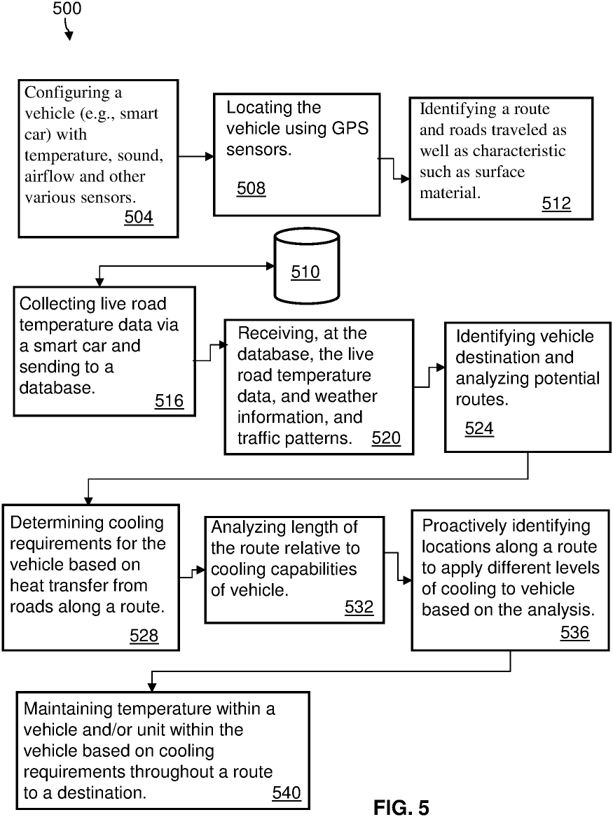

Generally referring to FIG. 5, in one embodiment according to the present disclosure, a system and method 500 can provide data analysis, modeling, and providing an output including temperature adjustments of a temperature controlled unit within a vehicle. In general, when a delivery vehicle is planned for transporting products and needs to maintain appropriate temperature, the delivery vehicle can use historical learning, crowd source data and material used for constructing the road, and accordingly identifying and initiating proactive cooling to a temperature controlled unit in the delivery vehicle.

In one example, a road surface temperature can be determined using sensors. The method 500 includes, in one example, a vehicle (e.g., smart car) can be configured with temperature, sound, airflow and other carious sensors, as in block 504. Such configuration can implemented by a computer, or a control system communicating remotely with a computer in the vehicle.

The method 500 includes locating the vehicle using GPS (Global Positioning System), as in block 508. The method includes identifying a route and roads traveled as well as characteristic such as surface material, as in block 512. For example, surface material can include concrete, tar, etc.

The method includes collecting live road temperature data via a smart car and sending to a database 510, as in block 516. For instance, historical data about road temperatures and routes, as well as, current temperature information, weather patterns and traffic pattern can be stored in database. The method includes receiving, at the database 510, the live road temperature data, and weather information, and traffic patterns, as in block 520. Such data can include data sent from crowdsourced vehicles which send temperature data and weather details, and other related information regarding their location and environment.

The method includes identifying vehicle destination and analyzing potential routes, as in block 524.

The method includes determining cooling requirements for the vehicle based on heat transfer from roads along a route, as in block 528. The method includes analyzing a length of the route relative to cooling capabilities of the vehicle, as in block 532. For instance, the analysis can include determining how long to apply a required amount of cooling in a refrigeration unit in a vehicle, while along a route.

The method includes proactively identifying location along a route to apply different levels of cooling to the vehicle based on the analysis, as in block 536. The method includes maintaining a temperature within the vehicle and/or unit within the vehicle based on cooling requirements throughout a route to a destination, as in block 540. Thereby, the method and system can include identifying when the delivery arrives at this location, then proactively cooling can be applied, so that when a unit, such as a refrigeration unit. For example, when a vehicle with a refrigeration unit is at a higher temperature road area, cooling can be applied properly on carried products in the vehicle.

Embodiments according to the present disclosure are able to autonomously predict the additional cooling requirements for a vehicle based on the upcoming road temperature and changing conditions. In another example, vehicle-to-vehicle network reporting can include a delivery vehicle connecting to crowdsource vehicles along with the selected route of the delivery vehicle to identify ambient temperature around and/or in the vicinity of the road surface in different portions of the road. Thus, based on the required cooling temperature to be maintained, a cooling system of the delivery vehicle can proactively maintain the cooling temperature inside the delivery vehicle or a unit of the delivery vehicle, so that while reaching a location, the required temperature will be maintained in the delivery vehicle.

In another example, road materials and connection data for vehicles can include the delivery vehicle electronically communicating and being connected to a smart city and can identify the types of material used for constructing the road. Accordingly, based on a material’s properties of the road, the delivery vehicle can estimate road surface ambient temperature, and can proactively maintain the temperature of the delivery vehicle.

In another example the system can monitor traffic conditions by identifying a traffic condition, speed of traffic, etc. Accordingly, the system can estimate how much heat dissipation is required to maintain a required temperature inside the delivery vehicle, and proactively apply proactive cooling.

In another example, a system can detect ambient temperature and weather data. Based on an ambient temperature around the road surface, and a distance of the road and speed of a delivery vehicle, a system can estimate how much heat dissipation is required, and accordingly the speed of a delivery vehicle can be adjusted as appropriate to maintain a delivery vehicle temperature or unit within the delivery vehicle.

In another example, a cooling model yielding cost minimization can be used by the delivery vehicle for estimating the power required to maintain proper cooling in a different route, considering the road properties, traffic condition etc. Accordingly, the delivery vehicle can identify an appropriate route so that cooling costs can be minimized.

Generally referring to FIG. 5, a method and system include a delivery vehicle for transporting products and needs to maintain appropriate temperature in the vehicle and/or a unit, and accordingly the delivery vehicle can use historic learning, crowd source data and research material used to construct the road. Accordingly, a vehicle can identify when proactive cooling is to be applied in the delivery vehicle.

In one example, an ambient temperature measurement can be determined using the vehicle using or communicating with ambient temperature measurement sensors. The vehicle can measure the ambient temperature. In another example, a GPS vehicle location can be determined when a vehicle is on the road, then with a GPS sensor the system can identify a geo-location of the vehicle. Road materials and composition of a road can be determined using a smart city transportation system for identifying how a road is constructed, what material is used, for example, tar, or concrete, etc. Sensors can be used to detect heat from actual road surfaces as different materials used for constructing roads will emit different radiation heat from the road surface.

In another example, vehicle road temperature collection can be initiated and received at a vehicle running on the road along a route and can send road surface temperature to a remote server. In one example, estimated road temperatures can be determined using a remote server and can estimate road surface temperature based on the types of material used. In another example, a road temperature corpus can be part of a system which can receive historical data capturing different road surface temperature in different weather conditions, and traffic conditions, etc.

In another example, a delivery vehicle location can be of a vehicle used for transporting product, can include the system identifying a current location of the delivery vehicle. The vehicle can use different routes and target destination. The delivery vehicle can identify the destination of the delivery vehicle, and different routes to the destination. The delivery vehicle can use a computer and sensors to implement data collections, and the delivery vehicle can connect to a remote server or can gather an input feed from crowd source vehicles. Route temperatures for road surfaces can be estimated by a computer and vehicle, and road surface temperature can be estimated in different portions of the road. Ambient temperatures on a route can be determined using a delivery vehicle identifying different portions of the road and the ambient temperature. Different routes and cooling requirements for a delivery vehicle can be estimated including how much cooling is required to travel along a different route. An estimated time to a target destination can be determined. A delivery vehicle can identifying how long it may take to reach a target location. In another example, a system can determine a length of cooling in a vehicle for an anticipated road condition. The system can analyze a capability of a cooling system, for instance, how long it talks to apply required cooling. The system can generate a prediction for when to start cooling the vehicle. In one example, a delivery vehicle, using a computer, can predict a time to reach a portion of the road, and what the temperature is at the portion of the road. In one example, a proactive cooling engagement can include a delivery vehicle for identifying when to start a proactive cooling in the delivery vehicle. In another example, a temperature prediction amelioration can be part of a system and can identify a road length and different temperature ranges, and accordingly estimate how much heat needs to be dissipated from a delivery vehicle to maintain a refrigeration temperature. In another example, a system can identify when proactive cooling is to be applied in the delivery vehicle. In one example, ongoing temperature prediction management can include a delivery vehicle reaching a destination, and the delivery vehicle maintaining a required temperature.

Thereby, according to embodiments of the present disclosure, a computer, in communication with a vehicle, can further adjust for determining a proactive cooling model based on a forecast of upcoming temperatures as the temperatures are both rising and falling beyond a known data point that is a current temperature. Embodiments of the present disclosure predict temperature proactively and then adjust the cooling accordingly before a unit reaches a threshold temperature. For example, embodiment can include a system which includes predicting a time of temperature readings at a different location, predicting weather condition in locations, and predicting what will be the temperature at a time or during a time. The system can include identifying materials used for building roads and can identify how much radiant heat is being emitted from a road surface after absorbing radiation from the sum which can affect ambient temperature. The system can predict traffic condition and can predicting a time to allow for heat dissipation. The system can also control the speed of a vehicle so that time spent in any high heat generation zone can be minimized.

### More Examples and Embodiments

Operational blocks and system components shown in one or more of the figures may be similar to operational blocks and system components in other figures. The diversity of operational blocks and system components depict example embodiments and aspects according to the present disclosure. For example, methods shown are intended as example embodiments which can include aspects/operations shown and discussed previously in the present disclosure, and in one example, continuing from a previous method shown in another flow chart.

### Additional Examples and Embodiments

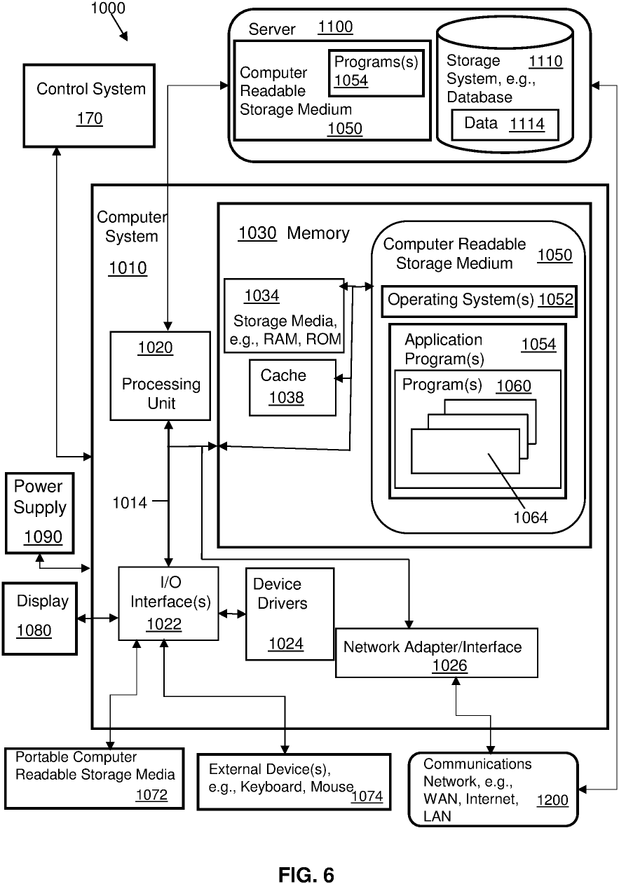

In the embodiment of the present disclosure shown in FIGS. 1 and 2, a computer can be part of a remote computer or a remote server, for example, remote server 1100 (FIG. 6). In another example, the computer 131 can be part of a control system 170 and provide execution of the functions of the present disclosure. In another embodiment, a computer can be part of a mobile device and provide execution of the functions of the present disclosure. In still another embodiment, parts of the execution of functions of the present disclosure can be shared between the control system computer and the mobile device computer, for example, the control system function as a back end of a program or programs embodying the present disclosure and the mobile device computer functioning as a front end of the program or programs.

The computer can be part of the mobile device, or a remote computer communicating with the mobile device. In another example, a mobile device and a remote computer can work in combination to implement the method of the present disclosure using stored program code or instructions to execute the features of the method(s) described herein. In one example, the device 130 can include a computer 131 having a processor 132 and a storage medium 134 which stores an application 135, and the computer includes a display 138. The application can incorporate program instructions for executing the features of the present disclosure using the processor 132. In another example, the mobile device application or computer software can have program instructions executable for a front end of a software application incorporating the features of the method of the present disclosure in program instructions, while a back end program or programs 174, of the software application, stored on the computer 172 of the control system 170 communicates with the mobile device computer and executes other features of the method. The control system 170 and the device (e.g., mobile device or computer) 130 can communicate using a communications network 160, for example, the Internet.

Thereby, the method 100 according to an embodiment of the present disclosure, can be incorporated in one or more computer programs or an application 135 stored on an electronic storage medium 134, and executable by the processor 132, as part of the computer on mobile device. For example, a mobile device can communicate with the control system 170, and in another example, a device such as a video feed device can communicate directly with the control system 170. Other users (not shown) may have similar mobile devices which communicate with the control system similarly. The application can be stored, all or in part, on a computer or a computer in a mobile device and at a control system communicating with the mobile device, for example, using the communications network 160, such as the Internet. It is envisioned that the application can access all or part of program instructions to implement the method of the present disclosure. The program or application can communicate with a remote computer system via a communications network 160 (e.g., the Internet) and access data, and cooperate with program(s) stored on the remote computer system. Such interactions and mechanisms are described in further detail herein and referred to regarding components of a computer system, such as computer readable storage media, which are shown in one embodiment in FIG. 6 and described in more detail in regards thereto referring to one or more computer systems 1010.

Thus, in one example, a control system 170 is in communication with the computer 131 or device 130, and the computer can include the application or software 135. The computer 131, or a computer in a mobile device 130 communicates with the control system 170 using the communications network 160.

In another example, the control system 170 can have a front-end computer belonging to one or more users, and a back-end computer embodied as the control system.

Also, referring to FIG. 1, a device 130 can include a computer 131, computer readable storage medium 134, and operating systems, and/or programs, and/or a software application 135, which can include program instructions executable using a processor 132. These features are shown herein in FIG. 1, and other similar components and features are also in an embodiment of a computer system shown in FIG. 6 referring to a computer system 1010, which may include one or more computer components.

The method according to the present disclosure, can include a computer for implementing the features of the method, according to the present disclosure, as part of a control system. In another example, a computer as part of a control system can work in corporation with a mobile device computer in concert with communication system for implementing the features of the method according to the present disclosure. In another example, a computer for implementing the features of the method can be part of a mobile device and thus implement the method locally.

Specifically, regarding the control system 170, a device(s) 130, or in one example devices which can belong to one or more users, can be in communication with the control system 170 via the communications network 160. In the embodiment of the control system shown in FIG. 1, the control system 170 includes a computer 172 communicating with a database 176 and one or more programs 174 stored on a computer readable storage medium 173. In the embodiment of the disclosure shown in FIG. 1, the device 130 communicates with the control system 170 and the one or more programs 174 stored on a computer readable storage medium 173. The control system includes the computer 172 having a processor 175, which also has access to the database 176.

The control system 170 can include a storage medium 180 for maintaining a registration 182 of users and their devices for analysis of the audio input. Such registration can include user profiles 183, which can include user data supplied by the users in reference to registering and setting-up an account. In an embodiment, the method and system which incorporates the present disclosure includes the control system (generally referred to as the back-end) in combination and cooperation with a front end of the method and system, which can be the application 135. In one example, the application 135 is stored on a device, for example, a computer or device on location, and can access data and additional programs at a back end of the application, e.g., control system 170.

The control system can also be part of a software application implementation, and/or represent a software application having a front-end user part and a back-end part providing functionality. In an embodiment, the method and system which incorporates the present disclosure includes the control system (which can be generally referred to as the back-end of the software application which incorporates a part of the method and system of an embodiment of the present application) in combination and cooperation with a front end of the software application incorporating another part of the method and system of the present application at the device, as in the example shown in FIG. 1 of a device 130 and computer 131 having the application 135. The application 135 is stored on the device or computer and can access data and additional programs at the back end of the application, for example, in the program(s) 174 stored in the control system 170.

The program(s) 174 can include, all or in part, a series of executable steps for implementing the method of the present disclosure. A program, incorporating the present method, can be all or in part stored in the computer readable storage medium on the control system or, in all or in part, on a computer or device 130. It is envisioned that the control system 170 can not only store the profile of users, but in one embodiment, can interact with a website for viewing on a display of a device such as a mobile device, or in another example the Internet, and receive user input related to the method and system of the present disclosure. It is understood that FIG. 1 depicts one or more profiles 183, however, the method can include multiple profiles, users, registrations, etc. It is envisioned that a plurality of users or a group of users can register and provide profiles using the control system for use according to the method and system of the present disclosure.

### Still Further Embodiments and Examples

It is understood that the features shown in some of the FIGS., for example block diagrams, are functional representations of features of the present disclosure. Such features are shown in embodiments of the systems and methods of the present disclosure for illustrative purposes to clarify the functionality of features of the present disclosure.

The methods and systems of the present disclosure can include a series of operation blocks for implementing one or more embodiments according to the present disclosure. In some examples, operational blocks of one or more FIGS. may be similar to operational blocks shown in another figure. A method shown in one FIG. may be another example embodiment which can include aspects/operations shown in another FIG. and discussed previously.

### Additional Embodiments and Examples

Account data, for instance, including profile data related to a user, and any data, personal or otherwise, can be collected and stored, for example, in the control system 170. It is understood that such data collection is done with the knowledge and consent of a user, and stored to preserve privacy, which is discussed in more detail below. Such data can include personal data, and data regarding personal items.

In one example a user can register 182 have an account 181 with a user profile 183 on a control system 170, which is discussed in more detail below. For example, data can be collected using techniques as discussed above, for example, using cameras, and data can be uploaded to a user profile by the user. A user can include, for example, a corporate entity, or department of a business, or a homeowner, or any end user, a human operator, or a robotic device, or other personnel of a business.

Regarding collection of data with respect to the present disclosure, such uploading or generation of profiles is voluntary by the one or more users, and thus initiated by and with the approval of a user. Thereby, a user can opt-in to establishing an account having a profile according to the present disclosure. Similarly, data received by the system or inputted or received as an input is voluntary by one or more users, and thus initiated by and with the approval of the user. Thereby, a user can opt-in to input data according to the present disclosure. Such user approval also includes a user’s option to cancel such profile or account, and/or input of data, and thus opt-out, at the user’s discretion, of capturing communications and data. Further, any data stored or collected is understood to be intended to be securely stored and unavailable without authorization by the user, and not available to the public and/or unauthorized users. Such stored data is understood to be deleted at the request of the user and deleted in a secure manner. Also, any use of such stored data is understood to be, according to the present disclosure, only with the user’s authorization and consent.

In one or more embodiments of the present invention, a user(s) can opt-in or register with a control system, voluntarily providing data and/or information in the process, with the user’s consent and authorization, where the data is stored and used in the one or more methods of the present disclosure. Also, a user(s) can register one or more user electronic devices for use with the one or more methods and systems according to the present disclosure. As part of a registration, a user can also identify and authorize access to one or more activities or other systems (e.g., audio and/or video systems). Such opt-in of registration and authorizing collection and/or storage of data is voluntary and a user may request deletion of data (including a profile and/or profile data), un-registering, and/or opt-out of any registration. It is understood that such opting-out includes disposal of all data in a secure manner. A user interface can also allow a user or an individual to remove all their historical data.

### Other Additional Embodiments and Examples

In one example, Artificial Intelligence (AI) can be used, all or in part, for generating a model or a learning model as discussed herein in embodiments of the present disclosure.

An Artificial Intelligence (AI) System can include machines, computer, and computer programs which are designed to be intelligent or mirror intelligence. Such systems can include computers executing algorithms. AI can include machine learning and deep learning. For example, deep learning can include neural networks. An AI system can be cloud based, that is, using a cloud-based computing environment having computing resources.

In another example, the control system 170 can be all or part of an Artificial Intelligence (AI) system. For example, the control system can be one or more components of an AI system.

It is also understood that the method 100 according to an embodiment of the present disclosure, can be incorporated into (Artificial Intelligence) AI devices, components or be part of an AI system, which can communicate with respective AI systems and components, and respective AI system platforms. Thereby, such programs or an application incorporating the method of the present disclosure, as discussed above, can be part of an AI system. In one embodiment according to the present invention, it is envisioned that the control system can communicate with an AI system, or in another example can be part of an AI system. The control system can also represent a software application having a front-end user part and a back-end part providing functionality, which can in one or more examples, interact with, encompass, or be part of larger systems, such as an AI system. In one example, an AI device can be associated with an AI system, which can be all or in part, a control system and/or a content delivery system, and be remote from an AI device. Such an AI system can be represented by one or more servers storing programs on computer readable medium which can communicate with one or more AI devices. The AI system can communicate with the control system, and in one or more embodiments, the control system can be all or part of the AI system or vice versa.

It is understood that as discussed herein, a download or downloadable data can be initiated using a voice command or using a mouse, touch screen, etc. In such examples a mobile device can be user initiated, or an AI device can be used with consent and permission of users. Other examples of AI devices include devices which include a microphone, speaker, and can access a cellular network or mobile network, a communications network, or the Internet, for example, a vehicle having a computer and having cellular or satellite communications, or in another example, IoT (Internet of Things) devices, such as appliances, having cellular network or Internet access.

### Further Discussion Regarding Examples and Embodiments

It is understood that a set or group is a collection of distinct objects or elements. The objects or elements that make up a set or group can be anything, for example, numbers, letters of the alphabet, other sets, a number of people or users, and so on. It is further understood that a set or group can be one element, for example, one thing or a number, in other words, a set of one element, for example, one or more users or people or participants. It is also understood that machine and device are used interchangeable herein to refer to machine or devices in one or more AI ecosystems or environments.

The descriptions of the various embodiments of the present invention have been presented for purposes of illustration, but are not intended to be exhaustive or limited to the embodiments disclosed. Likewise, examples of features or functionality of the embodiments of the disclosure described herein, whether used in the description of a particular embodiment, or listed as examples, are not intended to limit the embodiments of the disclosure described herein, or limit the disclosure to the examples described herein. Such examples are intended to be examples or exemplary, and non-exhaustive. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

### Further Additional Examples and Embodiments

Referring to FIG. 6, an embodiment of system or computer environment 1000, according to the present disclosure, includes a computer system 1010 shown in the form of a generic computing device. The method 100, for example, may be embodied in a program 1060, including program instructions, embodied on a computer readable storage device, or a computer readable storage medium, for example, generally referred to as computer memory 1030 and more specifically, computer readable storage medium 1050. Such memory and/or computer readable storage media includes non-volatile memory or non-volatile storage, also known and referred to non-transient computer readable storage media, or non-transitory computer readable storage media. For example, such non-volatile memory can also be disk storage devices, including one or more hard drives. For example, memory 1030 can include storage media 1034 such as RAM (Random Access Memory) or ROM (Read Only Memory), and cache memory 1038. The program 1060 is executable by the processor 1020 of the computer system 1010 (to execute program steps, code, or program code). Additional data storage may also be embodied as a database 1110 which includes data 1114. The computer system 1010 and the program 1060 are generic representations of a computer and program that may be local to a user, or provided as a remote service (for example, as a cloud based service), and may be provided in further examples, using a website accessible using the communications network 1200 (e.g., interacting with a network, the Internet, or cloud services). It is understood that the computer system 1010 also generically represents herein a computer device or a computer included in a device, such as a laptop or desktop computer, etc., or one or more servers, alone or as part of a datacenter. The computer system can include a network adapter/interface 1026, and an input/output (I/O) interface(s) 1022. The I/O interface 1022 allows for input and output of data with an external device 1074 that may be connected to the computer system. The network adapter/interface 1026 may provide communications between the computer system a network generically shown as the communications network 1200.

The computer 1010 may be described in the general context of computer system-executable instructions, such as program modules, being executed by a computer system. Generally, program modules may include routines, programs, objects, components, logic, data structures, and so on that perform particular tasks or implement particular abstract data types. The method steps and system components and techniques may be embodied in modules of the program 1060 for performing the tasks of each of the steps of the method and system. The modules are generically represented in the figure as program modules 1064. The program 1060 and program modules 1064 can execute specific steps, routines, sub-routines, instructions or code, of the program.

The method of the present disclosure can be run locally on a device such as a mobile device, or can be run a service, for instance, on the server 1100 which may be remote and can be accessed using the communications network 1200. The program or executable instructions may also be offered as a service by a provider. The computer 1010 may be practiced in a distributed cloud computing environment where tasks are performed by remote processing devices that are linked through a communications network 1200. In a distributed cloud computing environment, program modules may be located in both local and remote computer system storage media including memory storage devices.

More specifically, the system or computer environment 1000 includes the computer system 1010 shown in the form of a general-purpose computing device with illustrative periphery devices. The components of the computer system 1010 may include, but are not limited to, one or more processors or processing units 1020, a system memory 1030, and a bus 1014 that couples various system components including system memory 1030 to processor 1020.

The bus 1014 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

The computer 1010 can include a variety of computer readable media. Such media may be any available media that is accessible by the computer 1010 (e.g., computer system, or server), and can include both volatile and non-volatile media, as well as removable and non-removable media. Computer memory 1030 can include additional computer readable media in the form of volatile memory, such as random access memory (RAM) 1034, and/or cache memory 1038. The computer 1010 may further include other removable/non-removable, volatile/non-volatile computer storage media, in one example, portable computer readable storage media 1072. In one embodiment, the computer readable storage medium 1050 can be provided for reading from and writing to a non-removable, non-volatile magnetic media. The computer readable storage medium 1050 can be embodied, for example, as a hard drive. Additional memory and data storage can be provided, for example, as the storage system 1110 (e.g., a database) for storing data 1114 and communicating with the processing unit 1020. The database can be stored on or be part of a server 1100. Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 1014 by one or more data media interfaces. As will be further depicted and described below, memory 1030 may include at least one program product which can include one or more program modules that are configured to carry out the functions of embodiments of the present invention.

The method(s) described in the present disclosure, for example, may be embodied in one or more computer programs, generically referred to as a program 1060 and can be stored in memory 1030 in the computer readable storage medium 1050. The program 1060 can include program modules 1064. The program modules 1064 can generally carry out functions and/or methodologies of embodiments of the invention as described herein. The one or more programs 1060 are stored in memory 1030 and are executable by the processing unit 1020. By way of example, the memory 1030 may store an operating system 1052, one or more application programs 1054, other program modules, and program data on the computer readable storage medium 1050. It is understood that the program 1060, and the operating system 1052 and the application program(s) 1054 stored on the computer readable storage medium 1050 are similarly executable by the processing unit 1020. It is also understood that the application 1054 and program(s) 1060 are shown generically, and can include all of, or be part of, one or more applications and program discussed in the present disclosure, or vice versa, that is, the application 1054 and program 1060 can be all or part of one or more applications or programs which are discussed in the present disclosure. It is also understood that a control system 170, communicating with a computer system, can include all or part of the computer system 1010 and its components, and/or the control system can communicate with all or part of the computer system 1010 and its components as a remote computer system, to achieve the control system functions described in the present disclosure. The control system function, for example, can include storing, processing, and executing software instructions to perform the functions of the present disclosure. It is also understood that the one or more computers or computer systems shown in FIG. 1 similarly can include all or part of the computer system 1010 and its components, and/or the one or more computers can communicate with all or part of the computer system 1010 and its components as a remote computer system, to achieve the computer functions described in the present disclosure.

In an embodiment according to the present disclosure, one or more programs can be stored in one or more computer readable storage media such that a program is embodied and/or encoded in a computer readable storage medium. In one example, the stored program can include program instructions for execution by a processor, or a computer system having a processor, to perform a method or cause the computer system to perform one or more functions. For example, in one embedment according to the present disclosure, a program embodying a method is embodied in, or encoded in, a computer readable storage medium, which includes and is defined as, a non-transient or non-transitory computer readable storage medium. Thus, embodiments or examples according to the present disclosure, of a computer readable storage medium do not include a signal, and embodiments can include one or more non-transient or non-transitory computer readable storage mediums. Thereby, in one example, a program can be recorded on a computer readable storage medium and become structurally and functionally interrelated to the medium.

The computer 1010 may also communicate with one or more external devices 1074 such as a keyboard, a pointing device, a display 1080, etc.; one or more devices that enable a user to interact with the computer 1010; and/or any devices (e.g., network card, modem, etc.) that enables the computer 1010 to communicate with one or more other computing devices. Such communication can occur via the Input/Output (I/O) interfaces 1022. A power supply 1090 can also connect to the computer using an electrical power supply interface (not shown). Still yet, the computer 1010 can communicate with one or more networks 1200 such as a local area network (LAN), a general wide area network (WAN), and/or a public network (e.g., the Internet) via network adapter/interface 1026. As depicted, network adapter 1026 communicates with the other components of the computer 1010 via bus 1014. It should be understood that although not shown, other hardware and/or software components could be used in conjunction with the computer 1010. Examples, include, but are not limited to: microcode, device drivers 1024, redundant processing units, external disk drive arrays, RAID systems, tape drives, and data archival storage systems, etc.

It is understood that a computer or a program running on the computer 1010 may communicate with a server, embodied as the server 1100, via one or more communications networks, embodied as the communications network 1200. The communications network 1200 may include transmission media and network links which include, for example, wireless, wired, or optical fiber, and routers, firewalls, switches, and gateway computers. The communications network may include connections, such as wire, wireless communication links, or fiber optic cables. A communications network may represent a worldwide collection of networks and gateways, such as the Internet, that use various protocols to communicate with one another, such as Lightweight Directory Access Protocol (LDAP), Transport Control Protocol/Internet Protocol (TCP/IP), Hypertext Transport Protocol (HTTP), Wireless Application Protocol (WAP), etc. A network may also include a number of different types of networks, such as, for example, an intranet, a local area network (LAN), or a wide area network (WAN).

In one example, a computer can use a network which may access a website on the Web (World Wide Web) using the Internet. In one embodiment, a computer 1010, including a mobile device, can use a communications system or network 1200 which can include the Internet, or a public switched telephone network (PSTN) for example, a cellular network. The PSTN may include telephone lines, fiber optic cables, microwave transmission links, cellular networks, and communications satellites. The Internet may facilitate numerous searching and texting techniques, for example, using a cell phone or laptop computer to send queries to search engines via text messages (SMS), Multimedia Messaging Service (MMS) (related to SMS), email, or a web browser. The search engine can retrieve search results, that is, links to websites, documents, or other downloadable data that correspond to the query, and similarly, provide the search results to the user via the device as, for example, a web page of search results.

### Other Aspects and Examples

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user’s computer, partly on the user’s computer, as a stand-alone software package, partly on the user’s computer and partly on a remote computer or entirely on the remote computer or server. In the latter scenario, the remote computer may be connected to the user’s computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figure of the present disclosure illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

### Additional Aspects and Examples

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service’s provider.

Broad network access: capabilities are available over a network and accessed through standard mechanisms that promote use by heterogeneous thin or thick client platforms (e.g., mobile phones, laptops, and PDAs).

Resource pooling: the provider’s computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider’s applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

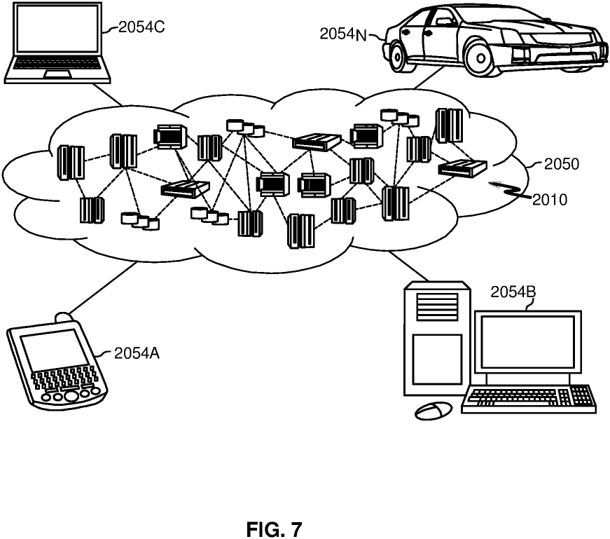

Referring now to FIG. 7, illustrative cloud computing environment 2050 is depicted. As shown, cloud computing environment 2050 includes one or more cloud computing nodes 2010 with which local computing devices used by cloud consumers, such as, for example, personal digital assistant (PDA) or cellular telephone 2054A, desktop computer 2054B, laptop computer 2054C, and/or automobile computer system 2054N may communicate. Nodes 2010 may communicate with one another. They may be grouped (not shown) physically or virtually, in one or more networks, such as Private, Community, Public, or Hybrid clouds as described hereinabove, or a combination thereof. This allows cloud computing environment 2050 to offer infrastructure, platforms and/or software as services for which a cloud consumer does not need to maintain resources on a local computing device. It is understood that the types of computing devices 2054A-N shown in FIG. 7 are intended to be illustrative only and that computing nodes 2010 and cloud computing environment 2050 can communicate with any type of computerized device over any type of network and/or network addressable connection (e.g., using a web browser).

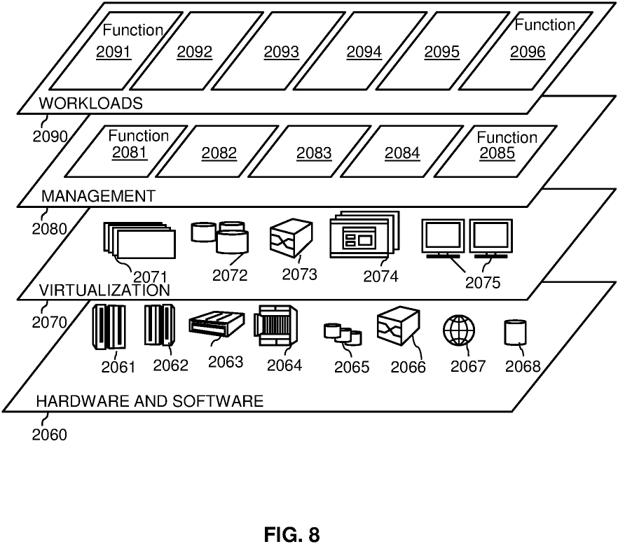

Referring now to FIG. 8, a set of functional abstraction layers provided by cloud computing environment 2050 (FIG. 7) is shown. It should be understood in advance that the components, layers, and functions shown in FIG. 8 are intended to be illustrative only and embodiments of the invention are not limited thereto. As depicted, the following layers and corresponding functions are provided:

Hardware and software layer 2060 includes hardware and software components. Examples of hardware components include: mainframes 2061; RISC (Reduced Instruction Set Computer) architecture based servers 2062; servers 2063; blade servers 2064; storage devices 2065; and networks and networking components 2066. In some embodiments, software components include network application server software 2067 and database software 2068.

Virtualization layer 2070 provides an abstraction layer from which the following examples of virtual entities may be provided: virtual servers 2071; virtual storage 2072; virtual networks 2073, including virtual private networks; virtual applications and operating systems 2074; and virtual clients 2075.

In one example, management layer 2080 may provide the functions described below. Resource provisioning 2081 provides dynamic procurement of computing resources and other resources that are utilized to perform tasks within the cloud computing environment. Metering and Pricing 2082 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 2083 provides access to the cloud computing environment for consumers and system administrators. Service level management 2084 provides cloud computing resource allocation and management such that required service levels are met. Service Level Agreement (SLA) planning and fulfillment 2085 provide pre-arrangement for, and procurement of, cloud computing resources for which a future requirement is anticipated in accordance with an SLA.

Workloads layer 2090 provides examples of functionality for which the cloud computing environment may be utilized. Examples of workloads and functions which may be provided from this layer include: mapping and navigation 2091; software development and lifecycle management 2092; virtual classroom education delivery 2093; data analytics processing 2094; transaction processing 2095; and data analysis of environmental data for managing energy conservation within a temperature controlled unit within a vehicle 2096, for example, a refrigerated vehicle.

What is claimed is:

1. A computer-implemented method for proactive temperature maintenance in a temperature controlled unit of a delivery vehicle based on computer data analysis of multiple temperature factors, comprising:
receiving route environmental data, at a computer, from a multiplicity of sources regarding temperatures outside a vehicle including a temperature at a current location and temperatures at another location along a route of the vehicle;
analyzing the route environmental data to determine when to initiate a proactive cooling action for maintaining a cooling requirement within a refrigerated space within the vehicle, the cooling requirements include a threshold temperature in the refrigerated space; and
initiating the proactive cooling action based on the analysis before the threshold temperature is reached by assessing temperature variations in the route environmental data for determining a temperature effect on the vehicle at one or more locations along the route.

2. The method of claim 1, wherein the maintaining of the cooling requirements includes maintaining a temperature range.

3. The method of claim 1, further comprising:
maintaining the cooling requirement as a result of the initiated proactive cooling action.

4. The method of claim 1, wherein the proactive cooling action is initiated in anticipation of initiating increased cooling by a refrigeration system to maintain the cooling requirements in the vehicle and avoid reaching the threshold temperature in the refrigerated space of the vehicle.

5. The method of claim 1, wherein the multiplicity of sources is from a plurality of wireless devices communicating with the computer.

6. The method of claim 1, wherein the sources include the location or locations along a route, or a road surface, or weather sensing sensors at the location or at the locations along the route.

7. The method of claim 1, wherein the computer is part of the vehicle.

8. The method of claim 1, wherein the computer is remote from the vehicle and communicates with a vehicle computer in the vehicle.

9. The method of claim 1, wherein a source of the multiplicity of the sources is a weather service system.

10. The method of claim 1, wherein the analysis of the data includes assessing a risk of the temperature reaching the threshold temperature at the one or more locations;
determining when the risk meets a risk threshold; and
the initiating of the proactive cooling action being based on the analysis and when the risk meets the risk threshold.

11. The method of claim 1, further comprising:
generating a model, using the computer, wherein the model includes the following;
updating the analysis of the route environmental data;
updating the assessing of the temperature variations of the route environmental data, and updating the determining of the temperature effect on the vehicle; and
updating the initiating of the proactive cooling action being based on the updated analysis and the updated assessing of the temperature variations.

12. The method of claim 11, further comprising:
iteratively generating the model to produce updated models.

13. A system for proactive temperature maintenance in a temperature controlled unit of a delivery vehicle based on computer data analysis of multiple temperature factors, which comprises:
a computer system comprising; a computer processor, a computer-readable storage medium, and program instructions stored on the computer-readable storage medium being executable by the processor, to cause the computer system to perform the following functions to;
receive route environmental data, at a computer, from a multiplicity of sources regarding temperatures outside a vehicle including a temperature at a current location and temperatures at another location along a route of the vehicle;
analyze the route environmental data to determine when to initiate a proactive cooling action for maintaining a cooling requirement within a refrigerated space within the vehicle, the cooling requirements include a threshold temperature in the refrigerated space; and
initiate the proactive cooling action based on the analysis before the threshold temperature is reached by assessing temperature variations in the route environmental data for determining a temperature effect on the vehicle at one or more locations along the route.

14. The system of claim 13, wherein the maintaining of the cooling requirements includes maintaining a temperature range.

15. The system of claim 13, further comprising:
maintaining the cooling requirement as a result of the initiated proactive cooling action.

16. The system of claim 13, wherein the proactive cooling action is initiated in anticipation of initiating increased cooling by a refrigeration system to maintain the cooling requirements in the vehicle and avoid reaching the threshold temperature in the refrigerated space of the vehicle.

17. The system of claim 13, wherein the multiplicity of sources is from a plurality of wireless devices communicating with the computer.

18. The system of claim 13, wherein the sources include the location or locations along a route, or a road surface, or weather sensing sensors at the location or at the locations along the route.

19. The system of claim 13, wherein the computer is part of the vehicle.

20. A computer program product for proactive temperature maintenance in a temperature controlled unit of a delivery vehicle based on computer data analysis of multiple temperature factors, the computer program product comprising a computer readable storage medium having program instructions embodied therewith, the program instructions executable by a computer to cause the computer to perform functions, by the computer, comprising the functions to;
receive route environmental data, at a computer, from a multiplicity of sources regarding temperatures outside a vehicle including a temperature at a current location and temperatures at another location along a route of the vehicle;
analyze the route environmental data to determine when to initiate a proactive cooling action for maintaining a cooling requirement within a refrigerated space within the vehicle, the cooling requirements include a threshold temperature in the refrigerated space; and
initiate the proactive cooling action based on the analysis before the threshold temperature is reached by assessing temperature variations in the route environmental data for determining a temperature effect on the vehicle at one or more locations along the route.
